(19) United States
(12) Patent Application Publication
(10) Pub. No.: US 2013/0055117 A1
(43) Pub. Date: Feb. 28, 2013

(54) USER INTERFACE VALIDATION ASSISTANT

(71) Applicants: Ali Raza Sahibzada, Bellevue, WA (US); Michael Eatherly, Puyallup, WA (US); Stephane Viot, Bellevue, WA (US); Gurinder Singh, Renton, WA (US)

(72) Inventors: Ali Raza Sahibzada, Bellevue, WA (US); Michael Eatherly, Puyallup, WA (US); Stephane Viot, Bellevue, WA (US); Gurinder Singh, Renton, WA (US)

(73) Assignee: Microsoft Corporation, Redmond, WA (US)

(21) Appl. No.: 13/222,734

(22) Filed: Aug. 31, 2011

(51) Int. Cl. G06F 3/048

(52) U.S. Cl. 715/762

(57) ABSTRACT

One or more techniques and/or systems are provided for analyzing a user interface. In particular, user interface (UI) elements within the user interface may be analyzed to detect potential issues, such as visual layout issues, functionality issues, and/or other issues with the user interface. In one example, property data of a UI element may be determined. For example, coordinates of the UI element, a string within the UI element, a translation of the string, dimensional units of the UI element, and/or a wide variety of other property data may be determined. The property data may be correlated together (e.g., analyzed) to determine a recommendation. For example, a string size of a string may be compared with a UI size of a UI element to determine whether the string visually fits within the UI element without truncation. In this way, the recommendation may identify issues and/or solutions to such issues.

### BACKGROUND

Many programming development environments provide developers with various programming tools, such as application building tools, debugging tools, performance analysis tools, and/or other tools. In this way, a developer may create a variety of robust user interfaces, such as graphical user interface applications, web applications, websites, and/or web services, within a development environment. Unfortunately, conventional development environments may not provide adequate validation tools for validating a user interface and/or user interface elements comprised therein (e.g., conventional validation tools may not detect and/or provide solutions for issues such as, truncation of text within a textbox, duplicate hotkey assignments to menu items, incorrect translation of text, etc.). Thus, a validation user may undertake manual validation of the user interface. Manual validation may be a time intensive task because the validation user may install the user interface, execute the user interface, and manually identify a series of potential issues (e.g., a substantial amount of time may be needed to manually gather and analyze sufficient data for validation, if such data is even available to the validation user). Moreover, identifying potential issues may involve information not readily available to the validation user (e.g., complex math and/or logic may be involved in determining whether a translation of text within a textbox may result in truncation of the translated text). Additionally, the level of manual validation may be further limited due to time constraints (e.g., a validation user may be allocated a limited amount of time to validate an application before the application is shipped). In this way, the validation user may perform a series of tedious and/or error prone manual steps to validate the product.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for analyzing a user interface are disclosed herein. It may be appreciated that a user interface (e.g., as used herein) may correspond to a variety of interfaces, such as a graphical user interface, a website, a web application, a web service, an application, and/or other user interfaces. The user interface may comprise one or more user interface (UI) elements, such as a text box, a drop down menu, a text label, a button, an image, and/or a variety of other UI elements. It may be advantageous to analyze the user interface and/or UI element comprised therein for validation, which may identify issues, such as formatting issues, translation issues, resource utilization issues, and/or other issues that may be associated with the user interface. Accordingly, a UI element within a user interface may be identified. In one example, the user interface may be automatically crawled for UI elements. In another example, user input associated with the UI element may be detected.

Property data associated with the UI element may be determined. It may be appreciated that property data may comprise a wide variety of information associated with the UI element, such as translation of text within the UI element (e.g., a translation service may translate text within a textbox to a different language), source code properties (e.g., source code associated with the UI element), system resources (e.g., system resources utilized by the UI element during execution), control properties (e.g., coordinates, size, bounding box properties, font, spatial coordinates in comparison with other UI elements, child UI elements, functionality, etc.), a screenshot (e.g., a screenshot of the UI element, which may be used for comparison), and/or other information associated with the UI element, such as direct or implicit characteristics and/or information about the UI element (e.g., information derived from complex mathematical computations). In one example, the property data may comprise first property data from a first data analysis component (e.g., the first data analysis component may identify an untranslated string within the UI element as the first property data). In another example, the property data may comprise second property data from a second data analysis component (e.g., the second data analysis component, such as an external language translation service, may determine a translation of the untranslated string into another language as the second property data). In this way, various information from local analysis components (e.g., a source code analyzer service, a UI element property analyzer service, a system resource utilization analyzer service, etc.) and/or information from external analysis components (e.g., an online translation service, an online trademark validation service, etc.) may be determined as the property data.

A recommendation may be determined based upon the first property data and/or the second property data. In one example, the first property data may be analyzed to determine the recommendation. For example, coordinates of a UI element button may be analyzed to determine whether the UI element button overlaps one or more other UI elements within the user interface. In another example, the first property data may be correlated with the second property data to determine the recommendation. For example, the first property data may correspond to a string size of a string within a UI element textbox, and the second property data may correspond to a UI size of the UI element textbox. The string size may be correlated with the UI size to determine whether a formatting issue exists between the string and the UI element (e.g., an issue may be detected if the string is visually too long/large to fit properly within the boundaries of the UI element textbox). It may be appreciated that the property data may comprise information received from one or more analysis components (e.g., third property data from a third data analysis component, fourth property data from a fourth data analysis component, etc.). For example, the property data may comprise third property data from a third data analysis component (e.g., a translation service may return a translation of the string as the third property data). Accordingly, a string size of the translated string may be compared with the UI size to determine whether a formatting issue exists between the translated string and the UI element. In this way, a recommendation for the UI element may be determined and/or utilized in validating the user interface (e.g., the recommendation may be made available for review, at least one property of the UI element may be modified to address an issue identified by the recommendation, etc.). It may be appreciated that terms such as “first”, “second”, “third”, etc. and/or the like are merely used as identifiers herein and are not intended to imply an ordering, a number of items, a location, a source, etc. unless specified as so intending.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of analyzing a user interface.

FIG. 2 is a flow chart illustrating an exemplary method of analyzing a user interface.

FIG. 3 is an illustration of an example of a user interface.

FIG. 4 is a component block diagram illustrating an exemplary system for analyzing a user interface.

FIG. 5 is an illustration of an example of implementing a recommendation associated with a photo management application.

FIG. 6 is an illustration of an example of providing a recommendation associated with a photo management application.

FIG. 7 is an illustration of an example validation report.

FIG. 8 is an illustration of an exemplary computer-readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

The development cycle of a user interface may involve extensive manual validation testing to identify potential issues with the user interface, such as translation issues (e.g., overlocalization of content, linguistics, terminology, etc.), visual layout issues (e.g., truncation, clipping, overlap, etc.), functionality issues (e.g., resource utilization issues, inconsistent behavior of UI elements, etc.), and/or other issues. Such manual validation may be tedious, prone to human error, and/or hindered by a lack of relevant information (e.g., a validation user may not have access to system resource data and/or information from external data analysis components, such as a translation analyzer service, readily available during manual validation). Unfortunately, conventional programming development environments do not provide adequate tools to aid in validation testing. For example, a conventional programming development environment may not provide adequate access to information, complex computational processing for identification of an issue, and/or complex computational processing for identifying and extracting data used for validation.

Accordingly, one or more systems and/or techniques for analyzing a user interface are provided herein. In particular, property data associated with a UI element within a user interface may be determined from various data analysis components (e.g., UI element style layout, dictionary font and size, trademark validation, hotkey data, source code data, system resource utilization data, and/or a plethora of information related to the UI element and/or the user interface). Unlike conventional techniques that may merely retrieve certain types of property data and/or make such property data available to a developer (e.g., a development environment may expose control properties, such as UI element style data, to the developer), the property data may be analyzed and/or correlated together to determine a recommendation for the UI element. In this way, various property data may be analyzed to determine the recommendation for the UI element, which may identify potential issues that may be associated with the UI element and/or may suggest solutions for how to address such issues (e.g., a UI size of the UI element may be automatically adjusted so that text within the UI element is not truncated when translated into a different language).

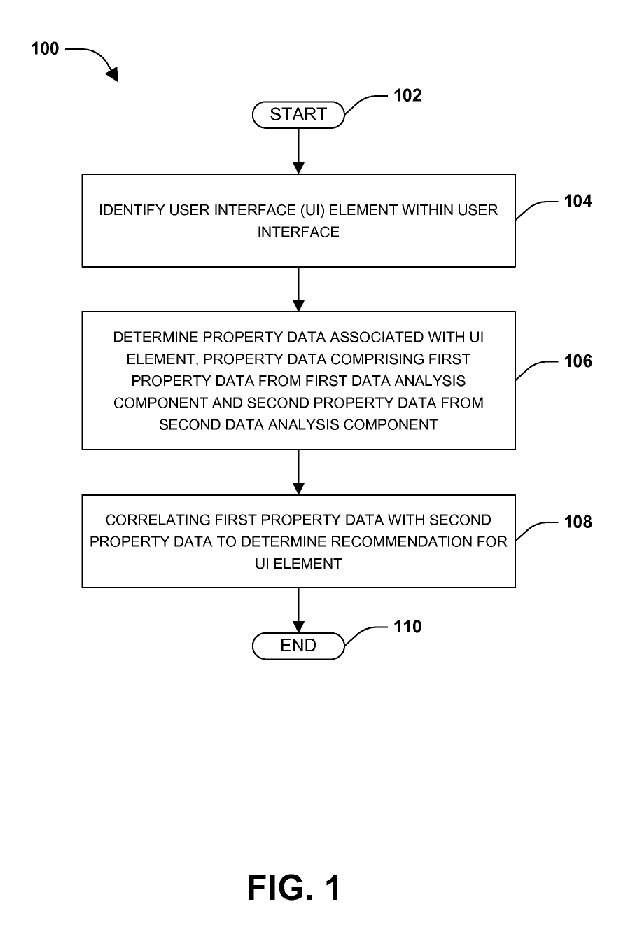

One embodiment of analyzing a user interface is illustrated by an exemplary method 100 in FIG. 1. At 102, the method starts. At 104, a user interface (UI) element within a user interface may be identified (e.g., the user interface may be automatically crawled for UI elements to identify the UI element, user input associated with the UI element may be detected, etc.). At 106, property data associated with the UI element may be determined. In one example, the property data may comprise first property data from a first data analysis component. In another example, the property data may also comprise second property data from a second data analysis component (e.g., the second data analysis component may provide different functionality and/or property data than the first data analysis component, and/or may reside at a same or different location than the first data analysis component (e.g., local, external, etc.)). It may be appreciated that the property data may correspond to a wide variety of information associated with and/or derived from the UI element, such as control properties (e.g., dimensional size of the UI element, HTML information of the UI element, hotkeys, UI element color, control tree, child UI elements, coordinates, etc.), source code properties (e.g., source code defining the UI element, programming functionality associated with UI element, parent/child control relationships of the UI element, a resource file associated with the UI element, etc.), system resources (e.g., a call stack, thread information, memory utilization, etc.), translation information (e.g., translation of a string within a UI element), a screenshot (e.g., a screenshot illustrating actual physical dimensions of the UI element and/or user interface when displayed during execution), and/or a variety of other information associated with the UI element and/or the user interface. In another example of property data, property data may relate to computed information, such as text to UI density, expected wrapping of text, and/or truncation or overlap due to insufficient space or due to currently used rendering algorithms.

It may be appreciated that the property data may comprise data from a variety of different data analysis components, such as a translation service, a trademark validation service, a string analyzer service, a source code analyzer service, a UI element property analyzer service, a screenshot service, and/or a plethora of other services. For example, the string analyzer service may accept a string associated with the UI element as input, and may output various string analysis information (e.g., character count of the string, font, string size, visible dimensions of string, determination as to whether string conforms to particular format, comparison of string with UI element properties, such as size, etc.) as property data. The source code analyzer service may accept the UI element as input, and may output source code associated with the UI element, functionality associated with the UI element, system resources associated with the UI element, and/or a wide variety of other (system-level) information as the property data. The UI element property analyzer service may accept the UI element as input, and may output various UI element properties (e.g., HTML properties of the UI element, a bounding box of the UI element, spatial relationship of the UI element compared with other UI elements, child UI elements of the UI element, etc.) as the property data.

It may be appreciated that the property data may be determined from local and/or remote data analysis components. That is, local data analysis components may provide local functionality, such as source code property analysis, system resource analysis, control property analysis (e.g., UI element property analysis), and/or other locally available functionality. Additionally, remote data analysis components may provide external functionality accessible from an external source, such as translation functionality provided by a translations web service, trademark functionality provided by a trademark analysis web service, an external string analyzer, and/or a wide variety of functionality, which may be provided by third parties, for example. It may be appreciated that in one example, an external source and/or a remote data analysis component may be comprised within a computing environment within which the application is being validated, and thus is not limited to residing within a different computing environment (e.g., an “external” string analyzer may reside within a computing environment within which the application is being validated).

At 108, the first property data may be correlated with the second property data to determine a recommendation for the UI element. In one example, a string within a textbox UI element may be determined (e.g., a source code analyzer may identify the string as a child UI element of the textbox UI element). A string size of the string may be received as the first property data from a UI element property analyzer service (e.g., in another example, the string size may correspond to a string size of a translation of the string from a first language to a second language using language translation functionality of a translation service). A UI size of the text box UI element may be received as the second property data from the UI element property analyzer service. A string analyzer service may determine whether a formatting issue, such as truncation, exists between the string and the textbox UI element based upon a comparison of the string size to the UI size (e.g., a recommendation identifying that the string is too long to fit within the UI element may be determined). In this way, various property data from one or more data analysis components (e.g., the UI element property analyzer service, the string analyzer service, a translation server, the translation service, etc.) may be correlated together to create the recommendation.

It may be appreciated that the example of correlating a string size property with a UI size property is merely one example, and that numerous other properties may be analyzed and/or correlated together to determine the recommendation. In one example, a string within a UI element may be analyzed by a trademark validation service to determine whether a trademark issue exists (e.g., improper trademark designation), which may be identified within the recommendation. In another example, a hotkey property of a first UI element may be correlated with a hotkey property of a second UI element to determine whether a duplicate hotkey issue exists, which may be identified within the recommendation. In another example, a position property of a first UI element may be correlated with a position property of a second UI element to determine whether an overlap issue exists, which may be identified within the recommendation. In another example, a translation of a string within a UI element from a first language to a second language may be correlated with dictionary definitions of the string in the first language and the second language to determine overlocalization issues (e.g., an intended meaning of a word may be lost with literal translation of the word from the first language to the second language), which may be identified within the recommendation. It may be appreciated that numerous comparisons and/or analysis may be performed when correlating property data to determine the recommendation, and the instant application, included the scope of the appended claims, is not intended to be limited by the examples provided herein.

It may be appreciated that the recommendation may comprise a variety of information (e.g., identification of one or more potential issues, general information regarding the UI element, results from the correlation of property data, suggestions on how to address potential issues, options to automatically address potential issues, etc.) that may be provided in various formats. In one example, the recommendation may identify an issue with the UI element (e.g., a duplicate hotkey issue, overlocalization of content, truncation, clipping, overlap, etc.). The identified issue may be automatically resolved based upon the recommendation (e.g., at least one property of the UI element may be modified based upon the recommendation, such as a size of a textbox UI element may be increased to accommodate a translation of a string within the textbox UI element). For example, source code associated with the application may be modified to address the identified issue. In another example, the recommendation may be presented as an interactive onscreen assistant associated with the user interface. In another example, the recommendation may be logged within a log file, emailed through email, and/or sent through an SMS message. In another example, a phone call may be initiated based upon the recommendation. In another example, a video comprising one or more screenshots of the UI element illustrating a potential issue and/or a solution may be provided. It may be appreciated that a confidence level may be associated with the recommendation (e.g., an indicator specifying how likely the potential issue exists, as opposed to merely being a false positive). Additionally, noise management and/or filtering of the correlation results may be provided based upon statistical information and/or the confidence level, etc. In another example, a triggering service may be implemented to schedule a compilation of the application after issues identified in the recommendation are addressed.

In another example, the correlation may comprise a statistical and/or historical analysis of the UI element. That is, prior property data and/or prior recommendations associated with the UI element may be compared (e.g., data trend analysis may be performed) with current property data and/or current recommendations to determine whether a consistency issue exists. For example, a consistency issue may exist when a current state of the UI element deviates from an expected behavior of the UI element as determined from a prior state of the UI element. The consistency issue may be used when determining the recommendation.

In another example, prior user feedback may be utilized to adjust the recommendation. For example, if the recommendation corresponds to a hotkey (e.g., “P”) being associated with multiple menu item UI elements (e.g. “Print” and “Paste”), then prior user feedback associated with prior similar recommendations may be consulted to determine whether to adjust the recommendation. For example, prior user feedback associated with a similar prior recommendation where multiple menu item UI elements were associated with a single hotkey (e.g., hotkey “S” may have been associated with menu items “Save” and “Save as”) may be identified. The prior user feedback may indicate that the user requested “Save” to retain the hotkey “S”, and that hotkey “S” was to be removed from “Save as” (e.g., the recommendation suggested that “Save as” may be assigned a new hotkey “A”). Accordingly, the current recommendation may suggest that hotkey “P” remain assigned to “Print” and/or that hotkey “P” be removed from “Paste”, for example.

In this way, automated processing, as opposed to tedious and/or error prone manual validation, of the user interface may enhance validation of the user interface and/or UI elements comprised therein. In one example, potential issues identified from correlating property data of UI elements may be automatically addressed. In another example, potential issues identified from correlating property data of UI elements may be provided within recommendations to a validation user for further action. At 110, the method ends.

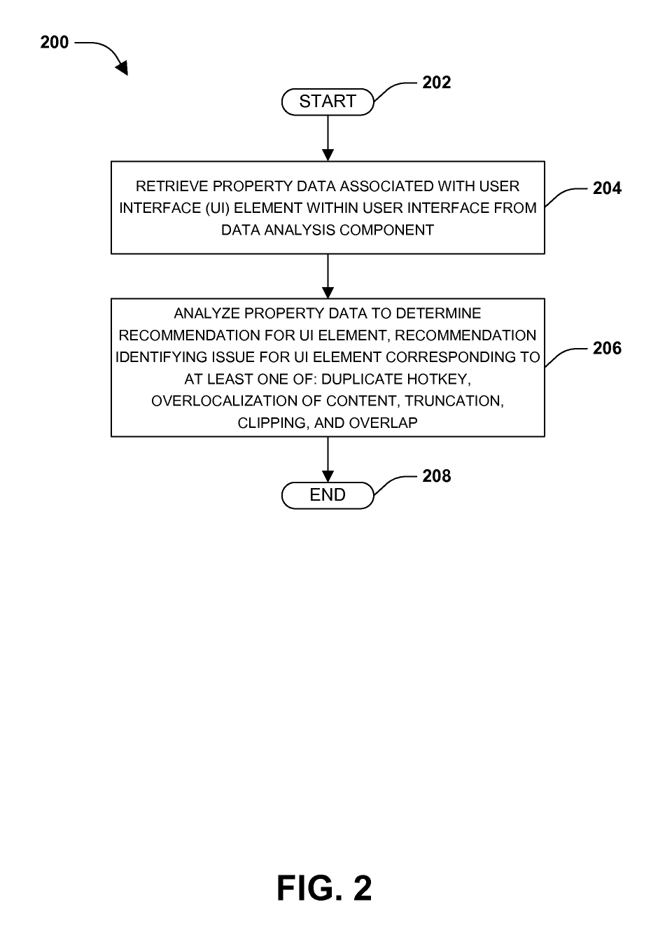

One embodiment of analyzing a user interface is illustrated by exemplary method 200 in FIG. 2. At 202, the method starts. At 204, property data associated with a user interface (UI) element within a user interface may be retrieved from a data analysis component (e.g., string size of a string within a textbox UI element and UI size of the textbox UI element may be retrieved as property data). At 206, the property data may be analyzed to determine a recommendation for the UI element. It may be appreciated that a variety of information may be utilized when analyzing the property data, such as property data of other UI elements, property data of child UI elements, system resource data, external information (e.g., information from a translation service and/or a string analysis service), etc. The recommendation may identify an issue for the UI element. For example, the issue may correspond to a duplicate hotkey, overlocalization of content, truncation, clipping, overlap, and/or a variety of other issues, such as visual formatting issues and/or functionality issues. In this way, the recommendation may be utilized in validating the user interface (e.g., the issue may be automatically addressed, the recommendation may be provided to a validation user, etc.). At 208, the method ends.

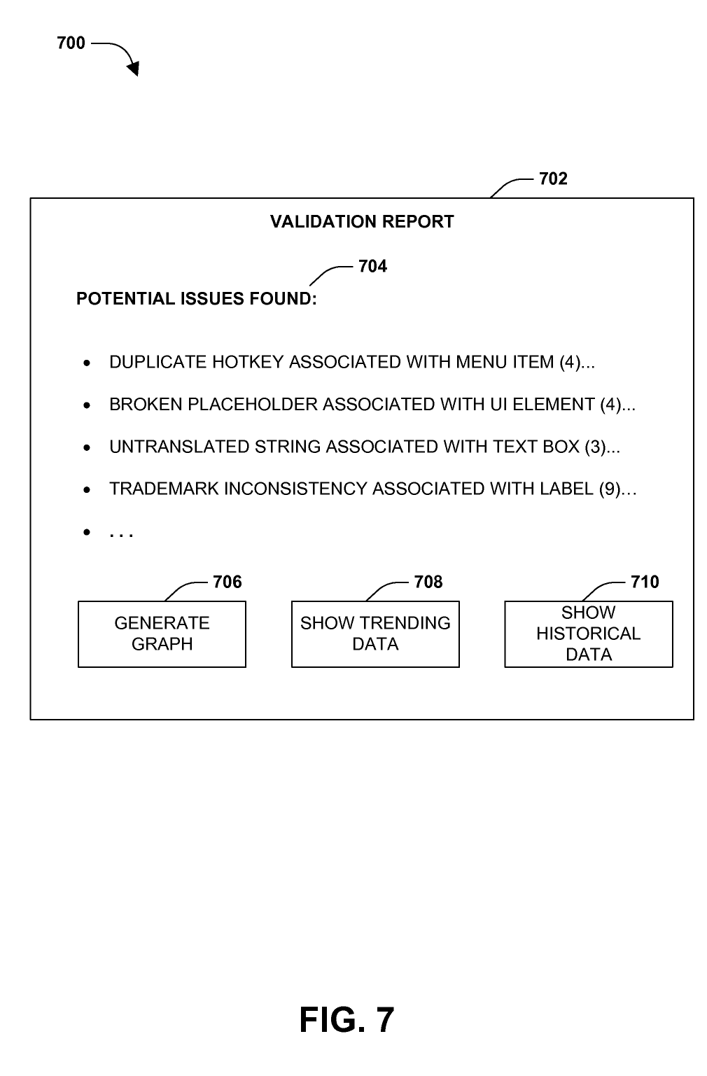

In one example, a validation report (e.g., validation report 702 of FIG. 7) may be generated based upon the correlating and/or the recommendation (e.g., the validation report may be generated based upon validating one or more UI elements of the application). For example, a report may comprise data variation associated with the UI element across one or more languages, historical data variation associated with the UI element across one or more builds of the application, trending data associated with a result of the correlating, a chart illustrating the result of the correlating, and/or a variety of other statistical and/or trending data.

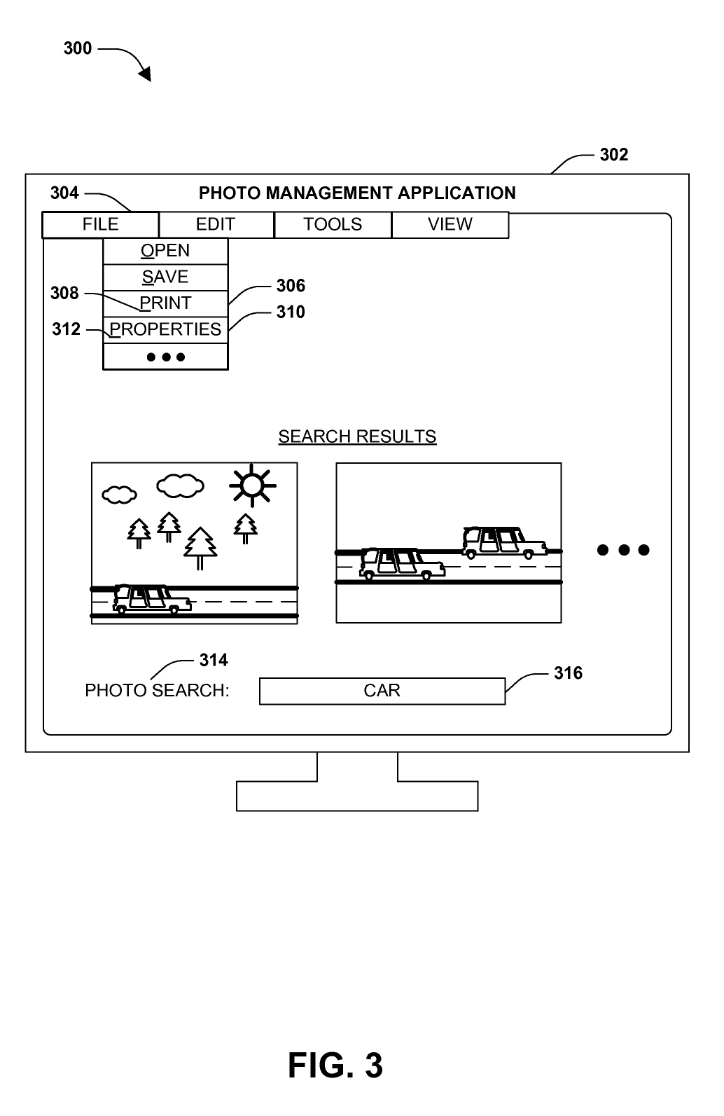

FIG. 3 illustrates an example 300 of a user interface. The user interface may comprise a photo management application 302. In one example, a developer may be developing the photo management application 302, and may desire validation of the photo management application 302. During validation of the photo management application 302 one or more issues may be identified, such as formatting issues (e.g., visual layout issues, such as truncation, clipping, overlap, etc.), functionality issues (e.g., a UI element may not operate as expected), and/or other issues (e.g., the photo management application 302 may be developed for multiple languages, however, when text is translated into another language, then various formatting issues and/or overlocalization issues may arise). Validation may be performed by evaluating various user interface (UI) elements within the photo management application 302, such as a file menu 304, a print menu item 306, a print hotkey “P” 308, a properties menu item 310, a properties hotkey “P” 312, a label 314, a textbox 316, and/or other UI elements within the photo management application 302. Instead of manual validation, it may be advantageous to provide validation functionality to assist a validation user in validating the photo management application 302. Such validation functionality may provide recommendations and/or address potential issues identified by analyzing and/or correlating property data of UI elements.

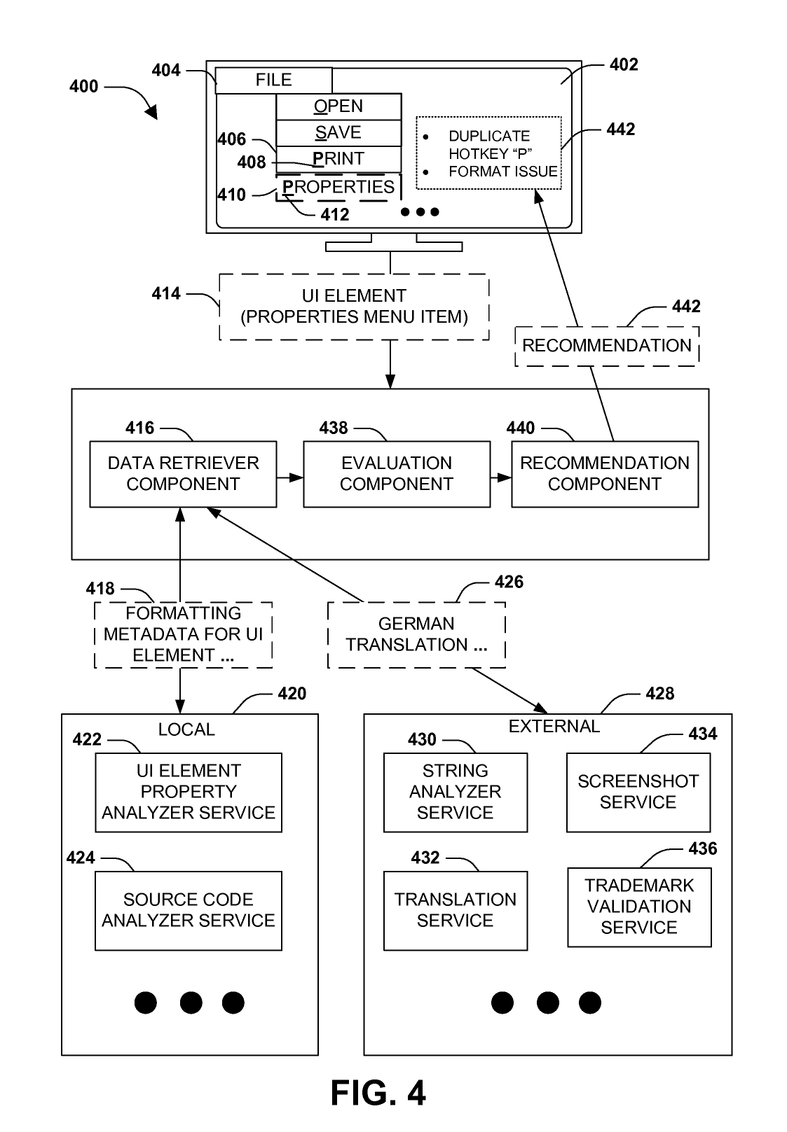

FIG. 4 illustrates an example of a system 400 configured for analyzing a user interface 402. The system 400 may comprise a data retriever component 416, an evaluation component 438, and/or a recommendation component 440. In one example, the user interface 402 may comprise one or more user interface (UI) elements, such as file menu 404, a print menu item 406, a print hotkey “P” 408, a properties menu item 410, a properties hotkey “P” 412, and/or other UI elements. A UI element 414 may be identified within the user interface 402 for analysis, such as properties menu item 410.

The data retriever component 416 may be configured to retrieve first property data associated with the properties menu item 410 from a first data analysis component. It may be appreciated that the data retrieve component may be configured to retrieve a variety of property data from various local sources 420 and/or external sources 428 (e.g., property data may be retrieve from a UI element property analyzer service 422, a source code analyzer service 424, a string analyzer service 430, a translation service 432, a screenshot service 434, a trademark validation service 436, and/or a plethora of other services that may provide property data associated with a UI element). For example, the data retriever component 416 may retrieve formatting metadata 418 as the first property data from the UI property analyzer service 422 (e.g., the formatting metadata 418 may comprise coordinates of the properties menu item 410, bounding box information of the properties menu item 410, dimensional information of the properties menu item 410, coordinates of the properties menu item 410 with respect to other UI elements within the user interface 402, information regarding the properties hotkey “P” 412, and/or other formatting information).

It may be appreciated that in one example, the data retriever component 416 may retrieve other property data, such as second property data from a second data analysis component. For example, the data retriever component 416 may retrieve a German translation 426 of the string “properties” within the properties menu item 410 (e.g., “Eigenschaften”). In this way, various property data may be utilized when determining a recommendation for a UI element.

The evaluation component 438 may be configured to analyze the first property data (e.g., formatting metadata 418) to determine a recommendation 442 for the properties menu item 410. For example, the evaluation component 438 may compare the properties hotkey “P” 412 with one or more hotkeys associated with the user interface 402. The evaluation component 438 may detect that “P” may be assigned to multiple UI elements as a hotkey (e.g., “P” may be assigned as properties hotkey “P” 412 and/or print hotkey “P” 408). The evaluation component 438 may determine that a duplicate hotkey issue may exist based upon analyzing the first property data (e.g., formatting metadata 418). In this way, the recommendation 442 may be determined. The recommendation 442 may identify the duplicate hotkey issue and/or provide a suggestion on how to address the duplicate hotkey issue.

In another example, the evaluation component 438 may correlate that first property data (e.g., formatting metadata 418) with the second property data (e.g., German translation 426) to determine the recommendation 442. For example, the evaluation component 438 may compare a string size of the German translation 426 of the string “properties” (e.g., “Eigenschaften”) with a UI size of the properties menu item 410 to determine whether “Eigenschaften” visually fits within the UI size of the properties menu item 410 without truncation. If “Eigenschaften” does not fit within the UI size of the properties menu item 410, then a format issue may be determined and/or included within the recommendation 442.

The recommendation component 440 may be configured to provide the recommendation 442 regarding the user interface 402. For example the recommendation component 440 may display the recommendation 442 within the user interface 402 as an onscreen assistant. It may be appreciated that the recommendation 442 may be provided through a variety of techniques, such as email, SMS message, a phone call, a log file, etc. The recommendation component 440 may be configured to modify at least one property of the properties menu item 410 based upon the recommendation 442 (e.g., the recommendation component 440 may be configured to automatically address issues identified within the recommendation 442). For example, the recommendation component 440 may expand the UI size of the properties menu item 410 to accommodate the German translation 426 “Eigenschaften” without truncation. In this way, validation of the user interface 402 may be improved based upon the recommendation 442 (e.g., numerous validation issues may be detected that may otherwise be overlooked during manual validation).

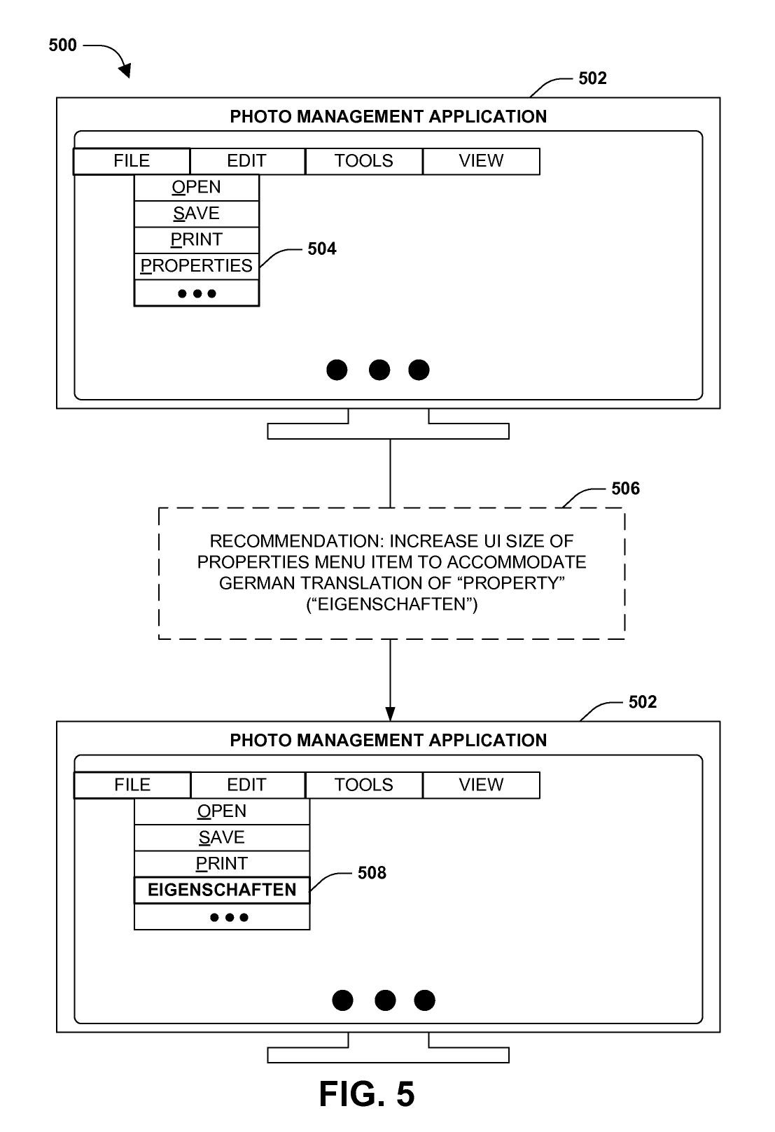

FIG. 5 illustrates an example 500 of implementing a recommendation 506 associated with a photo management application 502. To improve quality and/or resolve potential issues, such as visual and/or functional issues, associated with the photo management application 502, validation may be performed upon the photo management application 502. In one example, user interface (UI) elements, such as properties menu item 504, may be analyzed and/or correlated to determine a recommendation, such as the recommendation 506. The recommendation 506 may identify potential issues and/or solutions associated with the photo management application 502.

In one example, the properties menu item 504 may be analyzed. In particular, a UI size of the properties menu item 504, a string “properties” (e.g., a child UI element of the properties menu item 504), and/or other information may be retrieved from a UI element property analyzer service. Additionally, a German translation “Eigenschaften” of the string “properties” may be retrieved from a web translation service. A string size of the German translation “Eigenschaften” may be retrieved from a stringe analyzer service. The string size may be compared (e.g., correlated) with the UI size to determine whether the German translation “Eigenschaften” visually fits within the properties menu item 504 without truncation. Because the string size may be visually larger than the UI size, the recommendation 506 may be determined. The recommendation 506 may identify the formatting issue and/or provide a suggested solution, such as increasing the UI size of the properties menu item 504 to accommodate the German translation “Eigenschaften” of “properties”. In one example, the recommendation 506 may be implemented 508 (e.g., automatically implemented) by expanding the UI size of the properties menu item 504. In this way, the recommendation 506 may be implemented 508 to facilitate validation of the photo management application 502. It may be appreciated that various other issues associated with UI elements within the photo management application 502 may be identified and/or addressed. In one example, localization issues associated with a trademark name translated into one language as compared to being translated into another language may be identified and/or addressed.

It may be appreciated that data analysis components (e.g., a remote data analysis component, an external data analysis component, a local data analysis component, etc.) may configurable. For example, the mechanics of how a string analyzer may function may be configurable (e.g., the string analyzer may be configured to compare string length, compare character count, and/or may be configured to perform other functionality).

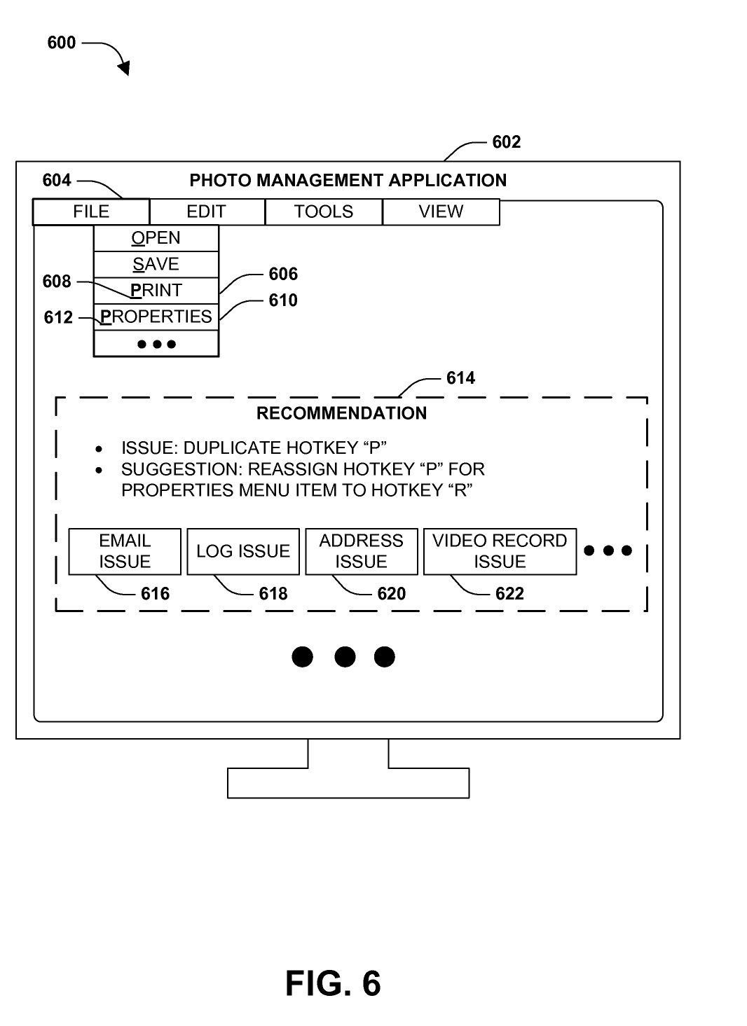

FIG. 6 illustrates an example 600 of providing a recommendation 614 associated with a photo management application 602. The photo management application 602 may comprise various user interface (UI) elements, such as a file menu 604, print menu item 606, a print hotkey “P” 608, a properties menu item 610, a properties hotkey “P” 612, and/or other UI elements. During analysis (e.g., validation) of the photo management application 602, property data associated with print menu item 606 may have been correlated with property data associated with properties menu item 610. For example, print hotkey “P” 608 may have been compared with properties hotkey “P” 612 to determine that a duplicate hotkey issues may exist. In this way, recommendation 614 may be determined based upon the correlation. For example, the recommendation 614 may identify the duplicate hotkey “P” issue and/or may specify a suggestion, such as reassigning hotkey “P” for the properties menu item 610 to hotkey “R”. The recommendation 614 may provide various actions that may be performed based upon the recommendation. In one example, the issue may be emailed 616 (e.g., the recommendation 614 may be emailed to a validation user and/or developer). In another example, the issue may be logged 618 (e.g., the recommendation 614 may be logged within a log file). In another example, the issue may be addressed 620 (e.g., the hotkey “P” for properties menu item 610 may be automatically reassigned to hotkey “R”). In another example, a video recording 622 may be created (e.g., snapshots illustrating the issue and/or the suggested solution may be created). In this way, the recommendation 614 may be utilized when validating the photo management application 602.

It may be appreciated that while non-translated hotkeys are illustrated in FIG. 6 (e.g., hotkeys and/or strings are illustrated in the English language), that hotkey issues may arise upon translations of a hotkey to another language. Accordingly, hotkey issues may be detected for untranslated and/or translated hotkeys.

FIG. 7 illustrates an example 700 of a validation report 702. The validation report 702 may be generated based upon validating one or more UI elements of an application. The validation report 702 may identify potential issues 704, such as duplicate hotkey issues, broken placeholder issues, untranslated strings, trademark inconsistencies, and/or a variety of other issues. The validation report 702 may provide additional information, such as graphical data and/or charts (e.g., generate graph option 706), trending data (e.g., show trending data option 708), historical data (e.g., show historical data option 710), and/or other information. In one example, the application may be automatically analyzed to generate the validation report 702.

It may be appreciated that the validation report 702 and/or functionality used to generate the validation report 702 may be based upon user configuration data/action(s). That is, the validation report 702 and/or information comprised therein, such as reporting data, trending data, historical data, and/or charts may be based upon user configuration data (e.g., a user may specify what charts to generate, what trends and/or data to extract, and/or what data analysis components to invoke, etc.). In one example, a user may customize reporting data by specifying what type of charts are to be generated and/or what data to include in such charts (e.g., a user may configure the validation report 702 to comprise a particular type of chart populated with reporting data associated with language based issues, but not trademark issues, for example). In another example, a user may customize trending data by specifying a particular set of issues and/or data to identify, evaluate and/or display (e.g., a user may configure the validation report 702 to comprise trending data associated with a particular set of UI elements). In another example, a user may customize what data analysis components are to be utilized when validating the application (e.g., a user may specify that a string data analysis component is to be invoked whenever a string within a UI element is encountered, and that the string data analysis component is to perform a string comparison on the encountered string in light of a German translation of the string). In this way, reporting, trending and/or triggers associated with data analysis components may be fully customizable.

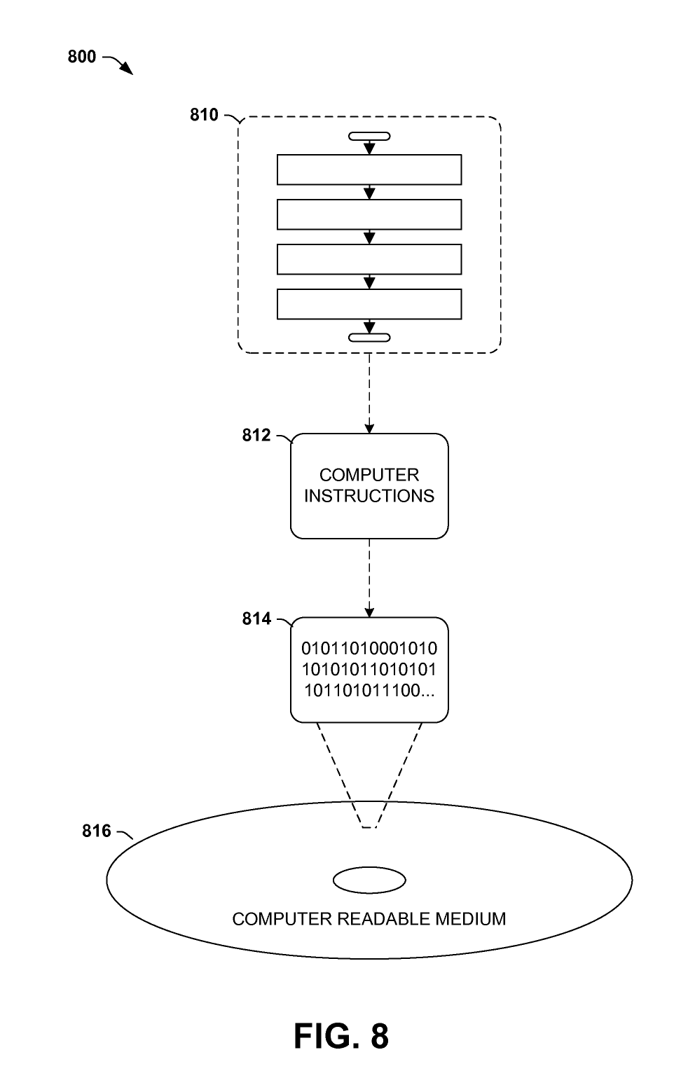

Still another embodiment involves a computer-readable medium comprising processor-executable instructions configured to implement one or more of the techniques presented herein. An exemplary computer-readable medium that may be devised in these ways is illustrated in FIG. 8, wherein the implementation 800 comprises a computer-readable medium 816 (e.g., a CD-R, DVD-R, or a platter of a hard disk drive), on which is encoded computer-readable data 814. This computer-readable data 814 in turn comprises a set of computer instructions 812 configured to operate according to one or more of the principles set forth herein. In one such embodiment 800, the processor-executable computer instructions 812 may be configured to perform a method 810, such as at least some of the exemplary method 100 of FIG. 1 and/or exemplary method 200 of FIG. 2, for example. In another such embodiment, the processor-executable instructions 812 may be configured to implement a system, such as at least some of the exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

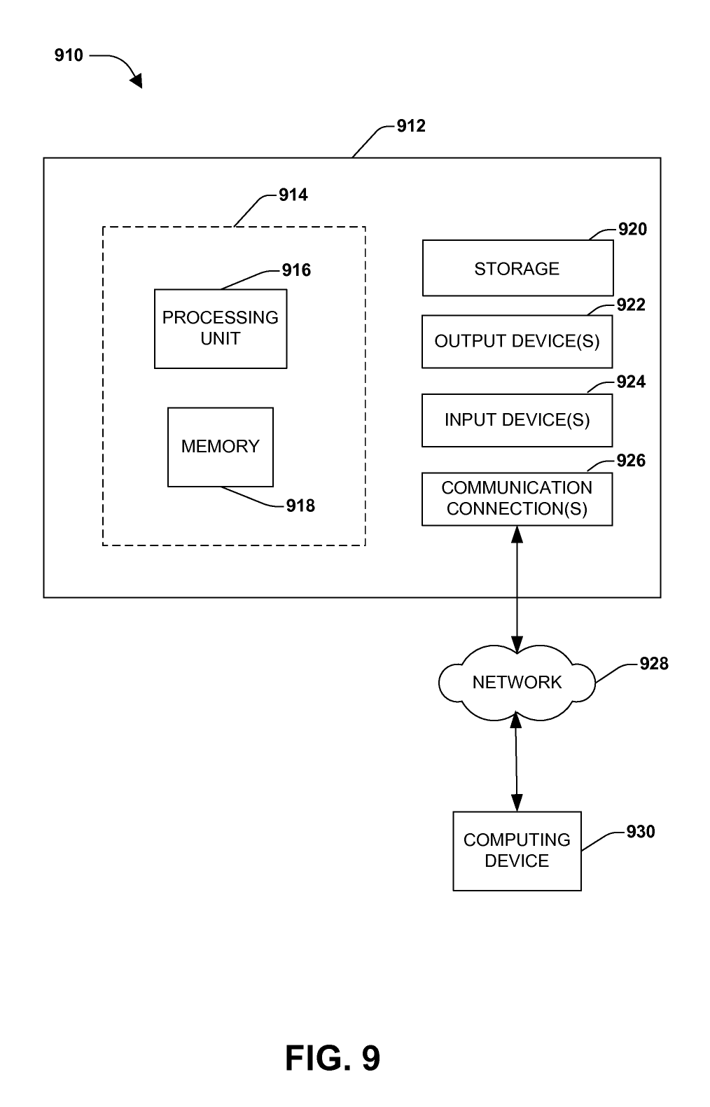

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for analyzing a user interface, comprising:
identifying a user interface (UI) element within a user interface;
determining property data associated with the UI element, the property data comprising first property data from a first data analysis component and second property data from a second data analysis component; and
correlating the first property data with the second property data to determine a recommendation for the UI element.

2. The method of claim 1, the first data analysis component different than the second data analysis component.

3. The method of claim 1, comprising:
providing the recommendation regarding the user interface, the providing comprising at least one of:
presenting the recommendation;
logging the recommendation into a log file;
sending an email comprising the recommendation;
sending an SMS message comprising the recommendation;
initiating a phone call associated with the recommendation; and
presenting a video comprising one or more screen shots associated with the UI element in light of the recommendation.

4. The method of claim 1, comprising:
modifying at least one property of the UI element based upon the recommendation.

5. The method of claim 1, the identifying a UI element comprising:
automatically crawling the user interface for UI elements to identify the UI element.

6. The method of claim 1, the determining property data comprising determining a string size of a string within the UI element as the first property data and determining a UI size of the UI element as the second property data, and the correlating comprising determining whether a formatting issue exists between the string and the UI element based upon a comparison of the string size to the UI size.

7. The method of claim 6, the string size comprising a translation of the string, the string translated using language translation functionality of the first data analysis component.

8. The method of claim 1, the property data comprising at least one of:
translation of text associated with the UI element;
source code properties associated with the UI element;
system resources associated with the UI element;
control properties associated with the UI element; and
a screenshot associated with the UI element.

9. The method of claim 1, comprising at least one of:
configuring the first data analysis component;
configuring the second data analysis component;
triggering a compilation action of the application after issues identified in the recommendation are addressed; and
generating a validation report based upon the correlating, the report comprising at least one of:
data variation associated with the UI element across one or more languages;
historical data variation associated with the UI element across one or more builds of the application;
trending data associated with a result of the correlating; and
a chart illustrating the result of the correlating, at least one of the validation report, the historical data, the trending data, and the chart based upon user configuration data.

10. The method of claim 1, the first data analysis component comprising external functionality accessible from an external source, and the second data analysis component comprising local functionality configured to access at least one of source code properties, system resources, and control properties associated with the UI element.

11. The method of claim 1, the first data analysis component comprising at least one of:
a translation service;
a trademark validation service;
a string analyzer service;
a source code analyzer service;
a UI element property analyzer service; and
a screenshot service.

12. The method of claim 1, comprising:
identifying prior user feedback associated with a prior recommendation similar to the recommendation, the prior user feedback indicating the prior recommendation was incorrect; and
adjusting the recommendation based upon the prior user feedback.

13. The method of claim 1, the correlating comprising:
determining whether a consistency issue exists between a current state of the UI element and a prior state of the UI element, the consistency issue indicating a deviation from an expected behavior of the UI element.

14. A system for analyzing a user interface, comprising:
a data retriever component configured to:
retrieve first property data associated with a user interface (UI) element within a user interface from a first data analysis component; and
an evaluation component configured to:
analyze the first property data to determine a recommendation for the UI element.

15. The system of claim 14, the recommendation identifying an issue for the UI element comprising at least one of: a duplicate hotkey, overlocalization of content, truncation, clipping, and overlap.

16. The system of claim 14, the data retriever component configured to retrieve second property data associated with the UI element from a second data analysis component, and the evaluation component configured to correlate the first property data and the second property data to determine the recommendation for the UI element.

17. The system of claim 16, the first data analysis component comprising external functionality accessible from an external source, and the second data analysis component comprising local functionality configured to access at least one of source code properties, system resources, and control properties associated with the UI element.

18. The system of claim 14, the first data analysis component comprising at least one of:
a translation service;
a trademark validation service;
a string analyzer service;
a source code analyzer service;
a UI element property analyzer service; and
a screenshot service.

19. The system of claim 14, comprising:
a recommendation component configured to at least one of:
modify at least one property of the UI element based upon the recommendation; and
provide the recommendation regarding the user interface, comprising at least one of: logging the recommendation, emailing the recommendation, SMS messaging the recommendation, initiating a phone call associated with the recommendation, and presenting video associated with the recommendation.

20. A computer readable medium comprising computer executable instructions that when executed via a processing unit on a computer perform a method for analyzing a user interface comprising:
retrieving property data associated with a user interface (UI) element within a user interface from a data analysis component; and
analyzing the property data to determine a recommendation for the UI element, the recommendation identifying an issue for the UI element comprising at least one of: a duplicate hotkey, overlocalization of content, truncation, clipping, and overlap.
